(19) United States
(12) Patent Application Publication
(10) Pub. No.: US 2025/0369121 A1
(43) Pub. Date: Dec. 4, 2025

(54) METHOD FOR ETCHING A PLASTIC SUBSTRATE INCLUDING SPRAYING AND ELECTROLYTIC REGENERATION

(71) Applicant: ATOTECH DEUTSCHLAND GMBH & CO. KG, Berlin (DE)

(72) Inventors: Jens HEYDECKE, Berlin (DE); Michael MUIGG, Berlin (DE)

(73) Assignee: ATOTECH DEUTSCHLAND GMBH & CO. KG, Berlin (DE)

(21) Appl. No.: 18/874,641

(22) PCT Filed: Jun. 29, 2023
(86) PCT No.: PCT/EP2023/067944

§ 371 Date: Dec. 13, 2024

(30) Foreign Application Priority Data
Jun. 30, 2022 (EP) 22182438.6

(51) Int. Cl. C23C 18/24

(52) U.S. Cl. CPC C23C 18/24

(57) ABSTRACT

The present invention relates to a method for etching a plastic substrate, the method comprising the steps (A) to (C), wherein step (C) includes an immersion-free dispensing of an acidic etching composition comprising water and one or more than one manganese species. Furthermore, a dispensed acidic etching composition is treated in a regeneration compartment for regeneration by applying an electrical current and returned to the acidic etching composition.

### FIELD OF THE INVENTION

The present invention relates to a method for etching a plastic substrate, the method comprising the steps (A) to (C), wherein step (C) includes an immersion-free dispensing of an acidic etching composition comprising water and one or more than one manganese species. Furthermore, a dispensed acidic etching composition is treated in a regeneration compartment for regeneration by applying an electrical current and returned to the acidic etching composition.

### BACKGROUND OF THE INVENTION

Metallizing non-metallic substrates such as plastic substrates has a long history in modern technology. Typical applications are found in automotive industry as well as for sanitary articles.

However, making a plastic substrate receptive for a metal layer is demanding. Typically, a respective method essentially starts with a surface modification of the substrate's surface, typically known as etching. Usually, a sensitive balance is required in order to ensure a sufficient surface roughening without causing over-etching.

Many methods and etching compositions are known, including compositions comprising environmentally questionable chromium species, such as hexavalent chromium species (e.g. chromic acid). Although these compositions usually provide very strong and acceptable etching results, environmentally friendly alternatives are more and more demanded and to a certain extent already provided in the art. In many cases manganese-based etching compositions are utilized instead, which gain more and more popularity in the market, in particular permanganate-based etching compositions.

EP 3 666 926 A1 refers to a method of generating manganese-(III) ions from manganese-(II) ions in mixed aqueous acid solutions of sulfuric acid and alkane sulfonic acids using ozone, wherein efficiency of generation of the manganese-(III) ions from the manganese-(II) ions with the ozone is at least 60%. An electrolytic regeneration is denoted as a disadvantage.

JP 2003-013244 A refers to a method for depositing a catalyst for electroless plating onto the surface of a resin substrate. The method is characterized by etching the surface of the resin substrate with an etching solution including a Pd compound.

U.S. Pat. No. 8,603,352 B1 refers to a chrome-free composition of an acidic suspension of manganese compounds and manganese ions applied to an organic polymer surface to etch the surface.

EP 2 657 367 A1 refers to a pre-etching composition for the treatment on non-conductive substrates in a plating process for the deposition of a metal layer on the substrate surface.

Among those permanganate-based etching compositions, particularly alkaline permanganate-based etching compositions are known for quite a long time. However, their etching potential is limited compared to acidic permanganate-based etching compositions which typically provide much stronger and more efficient etching effects. However, on the downside, they suffer the severe disadvantage that in an acidic environment, permanganate ions quickly decompose. This requires either a constant replenishment of fresh permanganate ions or a constant recycling process for reforming permanganate ions, chemically or electrolytically.

The aforementioned requirements typically call for high energy consumption, lead to an undesirably high CO₂ footprint, and/or an intensive wastewater treatment upon disposal.

In particular, a constant electrolytic regeneration of manganese species, particularly of permanganate, requires constantly high energy consumption.

It is therefore a critical demand to provide further improved etching methods utilizing an acidic, manganese-based etching composition, with reduced efforts to maintain the active manganese species, most preferably permanganate ions. Furthermore, it is desirable to further reduce the environmental impact of such etching compositions.

### OBJECTIVE OF THE PRESENT INVENTION

It is therefore the objective of the present invention to provide a method for etching a plastic substrate with a significantly reduced effort of maintaining the active manganese species, a reduced environmental impact and energy consumption to do so, but without compromising the etching quality.

### SUMMARY OF THE INVENTION

The above-mentioned objectives are solved by a method for etching a plastic substrate (1), the method comprising the steps
(A) providing an etching compartment (10) and a regeneration compartment (30),
(B) providing the plastic substrate (1) in the etching compartment (10),
(C) contacting the plastic substrate (1) in the etching compartment (10) with an acidic etching composition comprising
   (a) water, and
   (b) one or more than one manganese species,
   such that an etched plastic substrate is obtained,
characterized in that
the contacting in step (C) is an immersion-free dispensing of the acidic etching composition onto the plastic substrate (1), resulting in a dispensed acidic etching composition, and
at least a portion of the dispensed acidic etching composition is treated in the regeneration compartment (30) for regeneration by applying an electrical current and returned to the acidic etching composition.

The method of the present invention is combining two essential features. First, an immersion-free dispensing of the acidic etching composition instead of a commonly immersion/dipping/submersion of a plastic substrate into a respective acidic etching composition. Second, at least a portion of the dispensed acidic etching composition is treated in a regeneration compartment (i.e. recycled and regenerated, respectively) and returned (i.e. replenished) to the acidic etching composition. This combination generally allows a significantly reduced effort, including less energy and resource consumption, to maintain the acidic etching composition in its active state for a very desired and effective etching.

Therefore, in the method of the present invention, the plastic substrate (1) is not immersed, submersed, and/or dipped into the acidic etching composition. Instead, in the method of the present invention, the acidic etching composition is actively brought into contact (i.e. by means of the dispensing) with the plastic substrate instead of bringing actively into contact the plastic substrate with the etching composition as it is the case for common immersion/dipping/submersion methods. Thus, in the method of the present invention, the plastic substrate is rather static, wherein the acidic etching composition is in a mobile state, wherein in common immersion/dipping/submersion methods the etching composition as an etching bath is in a static condition (i.e. confined by tank walls) while the plastic substrate is mobile and lifted into the etching composition for etching. Also, in the context of the present invention, most preferably the only etching is the etching as defined in step (C) i.e. as a result of dispensing the acidic etching composition. Preferably, no other etching of the plastic substrate is applied. In other words, the method of the present invention is preferably a one-step etching.

The skilled person is aware that immersion free dispensing has a couple of disadvantages: Therefore, the skilled person had immersion free dispensing not considered as the etching method. Disadvantages of immersion free dispensing are well-known to the skilled person:
Formation of aerosols due to fine dispersed droplets
Technical effort is higher than just immersion
Energy demand for transport and dispersion of solution and.
Energy demand for heating to compensate the chilling effect caused by evaporation of water caused by the huge specific surface of formed droplets
Access of areas on backside of substrates like holes, caverns, and undercuts
Higher throughput for same volume and subsequent drag in of solutions, i.e. water and organics, of prior treatment step.

The list of disadvantages is not exhaustive.

In has been surprisingly found by the inventors that the inventive method is advantageous over the prior art. Without wanting to be bound by a particular theory it is assumed that a regeneration effort caused by the reduced volume could be reached without generating the disadvantages described above.

In particular, experiments have shown that the selected applied pressure and type of nozzles exhibit surprisingly low formation of fine dispersed droplets of the etchant. Aerosol measurements near the etchant chamber showed no detectable aerosols. Results were below the detection limits. Emitted acid was typically 100 times below limits or even lower, and emitted manganese was typically 20 times below limits or even lower.

Since the immersion-free dispensing dramatically reduces the required volume of the acidic etching composition compared to a common immersion/dipping/submersion method, a significantly reduced total volume of the acidic etching composition must be provided in the entire method. This has the major advantage that also a significantly reduced volume must be treated in the respective regeneration compartment. This reduces the extent of required electrical current (as well as any other means for oxidation) for regeneration because the overall amount of manganese species subjected to decomposition is likewise significantly reduced. Own examples have shown that in a direct comparison, up to 80% of electrical energy can be saved compared to an immersion/dipping/submersion method likewise combined with an electrolytic regeneration.

In addition, a such significantly reduced total volume requires less amounts of chemicals and therefore reduces the environmental impact, e.g. upon disposal. Furthermore, own experiments have shown a number of further advantages:

Compared to an immersion/dipping method, the immersion-free dispensing utilized in the present invention allows a selective contacting, time- and location-wise. This means that e.g. dispense nozzles are preferably selectively active and inactive. As a result, thereof, e.g. the front side of a plastic substrate can be significantly etched wherein the rear is significantly spared. This is advantageous if e.g. (i) a plastic substrate comprises on the front a comparatively sophisticated surface geometry, which requires a more intense etching compared to the rear with a less sophisticated surface geometry requiring less intense etching, or (ii) if a two-component plastic substrate is to be etched, exposing different materials on different sides, wherein the one component requires more intense etching compared to the other component. Furthermore, dispense nozzles can be active for a certain time interval followed by a time interval of inactivity. In other words, a dispense pattern can be designed in view of the plastic substrate requirements, even without means for covering at least partly the surface of a respective plastic substrate.

Further, compared to an immersion/dipping method, the immersion-free dispensing utilized in the present invention allows a significantly improved temperature management of the acidic etching composition. Since decomposition is strongly temperature dependent, the acidic etching composition can have a specific temperature, which is ideally selected for an optimal etching, while the temperature during the treatment in the regeneration compartment can be significantly reduced to minimize the decomposition. Due to the fact that the immersion-free dispensing allows for a reduced total volume, the respective volumes for heating and cooling are also less compared to a common immersion/dipping method.

The higher water evaporation of immersion free dispensing was surprisingly found to be advantageous. It is concluded that it compensates the reduced water extraction by reduced regeneration capacity. Subsequently the electrolyte will not be diluted during operation and will be cooled due to the evaporation effect. As a result, the cooling power can be significantly reduced or even entirely removed due to this effect. This dramatically reduces the technical effort for electrolytic regeneration since cooling devices need not be integrated at all or can be reduced in size and capacity.

Further, compared to an immersion/dipping method, the immersion-free dispensing utilized in the present invention surprisingly reduces etching defects and improves wetting. As a matter of fact, immersion/dipping methods typically require a strong mixing and motion, respectively, of the etching composition. This often leads to gas bubble formation within the composition. Furthermore, side reactions, in particular decomposition processes, further form gas bubbles. If such gas bubbles adsorb on the surface of a plastic substrate, the etching is dramatically impaired on these spots. Own experiments have shown that the immersion-free dispensing, particularly a spraying, significantly prevents such a detrimental effect. This is even more significant if a plastic substrate has a very sophisticated surface geometry. This most preferably includes that the plastic substrate is not contacted with any surfactants, neither in a step directly prior to the etching step nor during the etching step. This completely prevents the undesired drag-in of surfactants into the etching composition. If surfactants are present, it is assumed that surfactants are oxidized and are not removed from the etching composition. As a result, they accumulate and the accumulation of surfactants and oxidized surfactants increase the capacity demand of the regeneration device. In addition. no water will be dragged into the etchant that leads to undesired dilution and requires further measures and energy to separate it.

### BRIEF DESCRIPTION OF THE FIGURE

FIG. 1 is a schematic drawing representing the method of the present invention, showing the principle thereof. The figure does not necessarily represent real size dimensions and ratios of the compartments and other equipment involved therein.

### REFERENCE SIGNS

1 plastic substrate and plurality of plastic substrates, respectively
2 rack
3 vertical gas flow
10 etching compartment
11 opening equipped with a door
12 plurality of dispense nozzles
13 dispense line
14 supply line
15 ventilation duct
16 liquid separator
17 pump
20 reservoir
21 inlet regeneration line
22 outlet regeneration line
30 regeneration compartment

### DETAILED DESCRIPTION OF THE INVENTION

### Step (A)

In step (A), the etching compartment (10) and the regeneration compartment (30) are provided.

Preferred is a method of the present invention, wherein the etching compartment (10) and the regeneration compartment (30) are distinct and separate compartments, which are preferably spatially divided.

The etching compartment is the place where the etching is carried out, wherein the regeneration compartment is the place where the regeneration takes place. Both compartments are preferably fluidically connected by transfer lines for transferring the acidic etching composition and the dispensed acidic etching composition, respectively. Further details are given below in the text in connection with a more detailed description of the figure.

Preferred is a method of the present invention, wherein the etching compartment is made of, or at least comprises, a material resistant to the acidic etching composition. Preferred materials are fluoropolymer plastics, most preferably one or more selected from the group consisting of polyvinylfluoride (PVF), polyvinylidene fluoride (PVDF), polytetrafluoroethylene (PTFE), and polychlorotrifluoroethylene (PCTFE), most preferably polyvinylidene fluoride (PVDF).

During step (C), the etching compartment comprises the plastic substrate. In order to avoid a release of dispensed acidic etching composition, the etching compartment is closed during step (C). This also includes that the etching compartment is sufficiently tight. Thus, preferred is a method of the present invention, wherein the etching compartment comprises an opening equipped with a door.

Typically, the plastic substrate preferably comprises a plurality of plastic substrates. In order to properly etch such a plurality, they are fixed on a rack (in the sense of being temporarily attached to the rack). Therefore, preferred is a method of the present invention, wherein the etching compartment comprises during step (C) a rack and the plastic substrate is fixed on the rack.

Preferred is a method of the present invention, wherein the etching compartment (10) comprises one or more than one dispense nozzle (12) for the immersion-free dispensing in step (C), preferably a plurality of dispense nozzles, most preferably a plurality of spray nozzles.

More preferred is a method of the present invention, wherein the etching compartment (10) comprises from 0.1 to 2 dispense nozzles per dm² total spray window area, preferably from 0.3 to 1.8, more preferably from 0.5 to 1.6, even more preferably from 0.7 to 1.4, most preferably from 0.9 to 1.3. This most preferably applies to spray nozzles.

Typically, the plastic substrate and the plurality of plastic substrates, respectively, occupy a particular space within the etching compartment and preferably, the one or more than one dispense nozzle is located around thereof, most preferably laterally located with respect to the plastic substrate and the plurality of plastic substrates, respectively. This space is characterized typically by a certain edge length in three dimensions (height, depth, width), thereby typically defining a cuboid. In the context of the present invention, the term “total spray window area” denotes the total sum of the lateral surface area of this cuboid. The total spray window area is sometimes also named only “spray window” or “Warenfenster”.

In some cases, very preferred is a method of the present invention, wherein the etching compartment (10) comprises 5 to 1000 dispense nozzles, more preferably 10 to 600 dispense nozzles, even more preferably 30 to 400 dispense nozzles, yet even more preferably 50 to 200 dispense nozzles, most preferably 70 to 150 dispense nozzles. This preferably refers to one individual etching compartment (if more than one is utilized).

In some cases, even more preferred is a method of the present invention, wherein the etching compartment (10) comprises 10 to 700 spray nozzles, preferably 25 to 600 spray nozzles, more preferably 40 to 500 spray nozzles, even more preferably 50 to 400 spray nozzles, yet even more preferably 60 to 300 spray nozzles, most preferably 80 to 200 spray nozzles. This preferably refers to one individual etching compartment (if more than one is utilized). In this particular case, the one or more than one dispense nozzle is preferably one or more than one spray nozzle.

Preferred is a method of the present invention, wherein in the etching compartment (10) the one or more than one dispense nozzle (12) is inert towards the acidic etching composition. More preferred is a method of the present invention, wherein in the etching compartment (10) the one or more than one dispense nozzle (12) at least partly comprises or entirely consists of a fluoropolymer plastic, titanium, stainless steel, combinations, and/or composites thereof. A preferred fluoropolymer plastic is one or more selected from the group consisting of polyvinylfluoride (PVF), polyvinylidene fluoride (PVDF), polytetrafluoroethylene (PTFE), and polychlorotrifluoroethylene (PCTFE), most preferably polyvinylidene fluoride (PVDF).

Own experiments have shown that the etching compartment is not required to be airtight in order to prevent any mist of the acidic etching composition to escape (i.e. in the sense of leaking). Instead, an internal gas flow is in most cases sufficient to avoid this. Thus, preferred is a method of the present invention, wherein in the etching compartment (10) a vertical gas flow (3) is applied, preferably from top to bottom, to transport at least a portion of the dispensed acidic etching composition. This very efficiently prevents leaking. Thus, the vertical gas flow preferably comprises at least a portion of the dispensed acidic etching composition.

Preferred is a method of the present invention, wherein the vertical gas flow comprises ambient air, most preferably ambient air and at least a portion of the dispensed acidic etching composition. In some cases, it is preferred that the vertical gas flow alternatively or in addition comprises an inert protective gas, preferably nitrogen gas or a noble gas.

More preferred is a method of the present invention, wherein the vertical gas flow is applied in time intervals. Generally preferred is a method of the present invention, wherein the vertical gas flow is applied after the contacting in step (C) is finished, preferably until no dispensed acidic etching composition can escape if the door in the opening is opened for lifting out the plastic substrate, most preferably until essentially all of the dispensed acidic etching composition is removed from the etching compartment. This also preferably means that the vertical gas flow is applied during step (B) of a subsequent run-through of the method of the present invention. During step (C) the vertical gas flow is either not applied (i.e. is stopped) or applied with a reduced flow compared to the flow applied during step (B) and/or after the contacting in step (C) is finished.

Utilization of the vertical gas flow is an important safety feature. As a result thereof, a mixture of gas and dispensed acidic etching composition is obtained. Preferred is a method of the present invention, wherein the etching compartment comprises a ventilation duct (15) to suck off the vertical gas flow, the ventilation duct being connected to a liquid separator (16) to separate liquid from the gas flow. This results in a separated liquid, which contains dispensed acid etching composition in its liquid form and most preferably is transferred into reservoir (20).

Preferred is a method of the present invention, wherein the ventilation duct is located at or near the bottom of the etching compartment.

In step (A) also the regeneration compartment is provided for regeneration. The regeneration is carried out by applying an electrical current. Generally, the electrical current is oxidizing at least a portion of the one or more than one manganese species in the dispensed acidic etching composition which are thereby regenerated (i.e. recycled), resulting in forming the acidic etching composition ready for being utilized again in step (C) for the contacting. Most preferred, in the regeneration compartment permanganate ions are formed, i.e. manganese species with an oxidation number of +VII. This procedure is commonly named electrolytic re-oxidation. In the context of the present invention, it is a great benefit of the electrolytic re-oxidation that the total concentration of all manganese species together remains comparatively stable. As a matter of fact, besides replenishment of dragged-out manganese species, no manganese species are typically added to maintain the method. This contributes to a comparatively high process stability.

Preferred is a method of the present invention, wherein the regeneration is not a regeneration without applying an electrical current.

More preferred is a method of the present invention, wherein the regeneration does not involve ozone. This means that preferably ozone (most preferably as gas) is not intentionally added for regeneration.

Preferred is a method of the present invention, wherein the electrical current is a direct current (DC), preferably having a current density ranging from 0.1 A/dm² to 10 A/dm², preferably from 0.2 A/dm² to 7.5 A/dm², more preferably from 0.3 A/dm² to 5 A/dm², even more preferably from 0.4 A/dm² to 2.5 A/dm², most preferably from 0.5 A/dm² to 1 A/dm². Very preferred is a current density ranging from 0.1 A/dm² to 2 A/dm², more preferably from 0.2 A/dm² to 1 A/dm², most preferably from 0.3 A/dm² to 0.8 A/dm². The current density is the anodic current density.

Generally preferred is a method of the present invention, wherein the electrical current is permanently applied while the method of the present invention is carried out; most preferably even if between a first and a second step (C) a pause is applied.

Preferably, the electrical current, most preferably the permanently applied electrical current, prevents the presence of manganese species with the oxidation number +II.

Preferred is a method of the present invention, wherein the regeneration in the regeneration compartment is carried out at a temperature ranging from 20° C. to 65° C., preferably from 25° C. to 60° C., more preferably from 30° C. to 55° C., most preferably 35° C. to 50° C., even most preferably from 37° C. to 43° C.

In order to apply the electrical current, a cathode and an anode are typically required. Generally preferred is a method of the present invention, wherein in the generation compartment comprises at least one anode and at least one cathode.

Generally preferred is a method of the present invention, wherein the at least one anode and the at least one cathode have a distance ranging from 0.5 mm to 100 mm, preferably from 1 mm to 90 mm, more preferably from 2 mm to 80 mm, even more preferably from 3 mm to 70 mm, yet even more preferably from 4 mm to 60 mm, most preferably from 5 mm to 50 mm. More preferred is a method of the present invention, wherein the regeneration compartment (20) comprises a stack of a plurality of anodes and at least one cathode.

Even more preferred is a method of the present invention, wherein the stack of a plurality of anodes and the at least one cathode have a distance ranging from 0.5 mm to 100 mm, preferably from 1 mm to 90 mm, more preferably from 2 mm to 80 mm, even more preferably from 3 mm to 70 mm, yet even more preferably from 4 mm to 60 mm, most preferably from 5 mm to 50 mm. Most preferred is a method of the present invention, wherein the distance is ranging from 9 mm to 70 mm, preferably from 10 mm to 60 mm, more preferably from 11 mm to 50 mm, even more preferably from 12 mm to 30 mm, most preferably from 13 mm to 20 mm. Said distance is defined as the shortest distance between the at least one anode and the at least one cathode.

Preferred is a method of the present invention, wherein the regeneration compartment comprises at least one permeable barrier, preferably an ion-selective permeable barrier, most preferably an ion-selective permeable membrane.

Preferred is a method of the present invention, wherein the at least one permeable barrier is not mineral. Preferred is a method of the present invention, wherein the at least one permeable barrier is essentially free of, preferably does not comprise, a ceramic. In some cases, a method of the present invention is preferred, wherein the regeneration compartment does not comprise a permeable barrier.

More preferred is a method of the present invention, wherein the at least one permeable barrier is organic. More preferred is a method of the present invention, wherein the at least one permeable barrier is organic and comprises fluorine (preferably is fluorinated), most preferably is organic and perfluorinated. Most preferred, the at least one permeable barrier is a Nafion-type-membrane, although the at last one membrane is not particularly limited to this particular brand.

Such a barrier typically results in an anolyte sub-compartment comprising an anolyte and a catholyte sub-compartment comprising a catholyte. Preferably, the anolyte comprises, most preferably is, the dispensed acidic etching composition for regeneration.

Preferred is a method of the present invention, wherein the stack of the plurality of anodes comprises anode layers, preferably 3 or more than 3 anode layers, more preferably 3 to 300 anode layers, even more preferably 4 to 200 anode layers, yet even more preferably 6 to 100 anode layers, most preferably 8 to 60 anode layers, even most preferably 9 to 30 anode layers. Such a stack with anode layers surprisingly shows a very effective electrolytic regeneration without a too detrimental shielding. This also allows a very compact design of the regeneration compartment.

Preferred is a method of the present invention, wherein in the stack the anode layers have a distance to each other ranging from 0.5 mm to 20 mm, preferably from 1 mm to 15 mm, more preferably from 2 mm to 12 mm, even more preferably from 3 mm to 10 mm, most preferably from 4 mm to 9 mm. In some cases, a very preferred distance is ranging from 1 mm to 6 mm, preferably from 1.5 mm to 4 mm.

Preferred is a method of the present invention, wherein the at least one anode, preferably the stack of the plurality of anodes, most preferably the anode layers, comprises a sheet, a mesh, a woven web, and/or an expanded metal (i.e. a metal lath). Preferred is a method of the present invention, wherein the at least one anode, preferably the stack of the plurality of anodes, most preferably the anode layers, has a surface factor of 1 or more, preferably of 1.4 or more, even more preferably of 1.7 or more, yet even more preferably of 2 or more, most preferably of 2.1 or more, even most preferably of 2.2 or more. In the context of the present invention, the surface factor denotes a parameter defining the total effective surface area per geometric area. For example, a plate, i.e. a surface, geometrically of 1 m2 typically has a surface factor of 2 (for the sake of simplicity, the area of the cutting edges is neglected), which results in a total effective surface area of 2 m² (including front side and back side). As a result, the surface factor is without any dimensions/units. A surface factor below or even above 2 is typically obtained if e.g. a plate has holes and a mesh has openings, respectively, in a defined number and with defined dimensions. However, the surface factor of commercially available meshes today is typically not exceeding 2.5. In the context of the present invention, the surface factor as defined above most preferably applies to an individual anode layer in the stack.

Preferred is a method of the present invention, wherein the at least one anode, preferably the stack of the plurality of anodes, comprises platinum, titanium, niobium, lead, gold, alloys comprising at least one thereof, oxides thereof, and/or combinations thereof; preferably at least one of platinum, titanium, and gold.

As a matter of fact, not all anode materials are suitable for the purpose achieved with the method of the present invention. Since the etching composition is acidic and because of the strong oxidizing character of manganese species, the material for the anode must be carefully selected. A minimum requirement is that a respective material is (electro-) chemically inert towards the acidic etching composition. Very preferred is a method of the present invention, wherein the at least one anode and the stack of the plurality of anodes, respectively, comprises a platinized anode and/or a platinum anode, preferably a platinized titanium anode, and/or a platinized niobium anode.

Generally preferred is a method of the present invention, wherein the at least one cathode comprises stainless steel, zirconium, titanium, platinum, niobium, lead, alloys comprising at least one thereof, oxides thereof, and/or combinations thereof. Very preferred is stainless steel, platinized titanium, niobium, and/or zirconium.

Preferred is a method of the present invention, wherein the at least one cathode and the at least one anode (respectively the stack of the plurality of anodes) are vertically oriented, preferably vertically oriented and in parallel to each other.

Preferred is a method of the present invention, wherein the at least one anode (respectively the stack of the plurality of anodes) provides a total effective anode surface area A₁ and the at least one cathode a total effective cathode surface area A₂, wherein A₁ is larger than A₂. In the context of the present invention, “total effective surface area” refers to the area available for participation in the regeneration.

Preferred is a method of the present invention, wherein A₁:A₂ is ranging from 5:1 to 100:1, preferably from 10:1 to 85:1, more preferably from 15:1 to 70:1, even more preferably from 20:1 to 60:1, most preferably from 30:1 to 50:1. In some cases preferred is that A₁:A₂ is ranging from 5:1 to 30:1, preferably from 6:1 to 25:1, more preferably from 7:1 to 20:1.

### Step (B)

In step (B) the plastic substrate is provided in the etching compartment.

The substrate is a plastic substrate, alternatively also known as a polymer resin substrate (likewise an organic polymer substrate). Most preferably, the plastic substrate is a thermoplastic resin substrate.

Generally preferred is that the plastic substrate is vertically handled in the method of the present invention. Preferred is a method of the present invention, wherein in step (B) the providing comprises vertically moving in (e.g. a lifting) the plastic substrate into the etching compartment. Preferably, the etched plastic substrate is vertically moved out (e.g. a lifting) from the etching compartment after step (C).

Preferred is a method of the present invention, wherein the plastic substrate comprises butadiene moieties, preferably polybutadiene.

Also preferred is a method of the present invention, wherein the plastic substrate comprises nitrile moieties.

Also preferred is a method of the present invention, wherein the plastic substrate comprises acryl moieties.

Also preferred is a method of the present invention, wherein the plastic substrate comprises styrene moieties.

More preferred is a method of the present invention, wherein in step (B) the plastic substrate comprises acrylonitrile butadiene styrene (ABS), acrylonitrile butadiene styrene-polycarbonate (ABS-PC), polypropylene (PP), polyamide (PA), polyetherimide (PEI), a polyetherketone (PEK), epoxy resins, mixtures or composites thereof.

Preferred is a method of the present invention, wherein the polyetherketone (PEK) comprises polyaryletherketone (PAEK), poly ether ether ketone (PEEK), poly ether ether ether ketone (PEEEK), poly ether ether ketone ketone (PEEKK), poly ether ketone ether ketone ketone (PEKEKK), poly ether ketone ketone (PEKK), and/or mixtures thereof, preferably poly ether ether ketone (PEEK), polyaryletherketone (PAEK), and/or mixtures thereof.

In some cases, very preferred is a method of the present invention, wherein the plastic substrate comprises a 2-component (2K) plastic substrate, preferably comprising polycarbonate (PC) as one component. A preferred 2K plastic substrate comprises polycarbonate/acrylonitrile butadiene styrene-polycarbonate (PC/ABS-PC) and/or polycarbonate/acrylonitrile butadiene styrene (PC/ABS). The etching composition utilized in the method of the present invention selectively etches the ABS and ABS-PC without etching the PC component.

Preferred is a method of the present invention, wherein the plastic substrate comprises a plurality of plastic substrates, preferably a plurality of plastic substrates fixed on at least one rack. The use of metallization racks is common in decorative chromium plating, starting from treatments for etching a plastic substrate as described throughout the present text up to subsequent metallization steps. Particularly for decorative automobile parts, sanitary articles, and packing/storage materials this is very preferred.

Preferably, in the method of the present invention the plastic substrate is for decorative articles. Most preferably, the plastic substrate is a decorative automotive pre-part, a decorative sanitary pre-article, or a decorative packing/storage pre-material. In the context of the present invention, the term “pre” in combination with the plastic substrate means that by carrying out subsequent metallization steps on the etched plastic substrate results in a final plastic substrate for the desired function.

### Step (C)

In step (C) of the method of the present invention the plastic substrate (1) is contacted in the etching compartment with an acidic etching composition such that an etched plastic substrate is obtained. The acidic etching composition comprises
(a) water, and
(b) one or more than one manganese species.

As mentioned, the acidic etching composition comprises water, preferably is an aqueous acidic etching composition, most preferably water is the only solvent in the acidic etching composition. Preferably, the water has a concentration ranging from 10.8 mol/L to 27.5 mol/L, preferably from 12 mol/L to 26 mol/L, more preferably from 13.1 mol/L to 24.5 mol/L, even more preferably from 13.9 mol/L to 23.3 mol/L, most preferably from 14.7 mol/L to 22.6 mol/L.

As also mentioned, the etching composition is acidic. Preferred is a method of the present invention, wherein the acidic etching composition is strongly acidic, preferably has a pH of 2 or below, more preferably of 1 or below, even more preferably of 0.5 or below, most preferably of zero or below.

Preferred is a method of the present invention, wherein all of the one or more than one manganese species has a total concentration ranging from 0.005 mol/L to 0.3 mol/L, based on the total volume of the acidic etching composition, preferably from 0.01 mol/L to 0.25 mol/L, more preferably from 0.015 mol/L to 0.2 mol/L, even more preferably from 0.02 mol/L to 0.15 mol/L, yet even more preferably from 0.025 mol/L to 0.11 mol/L, most preferably from 0.03 mol/L to 0.09 mol/L.

Preferred is a method of the present invention, wherein in the acidic etching composition the one or more than one manganese species comprises permanganate ions, preferably the acidic etching composition is an acidic permanganate-based etching composition. This preferably means that in the acidic etching composition permanganate ions are an active etching species, most preferably the active etching species, even most preferably the most active etching species. More preferred is a method of the present invention, wherein in the acidic etching composition 5 mol.-% to 35 mol.-% of all manganese species are permanganate ions, preferably 8 mol.-% to 30 mol.-%, more preferably 10 mol.-% to 27 mol.-%, most preferably 12 mol.-% to 21 mol.-%.

Preferred is a method of the present invention, wherein the permanganate ions have a concentration ranging from 0.002 mol/L to 0.09 mol/L, based on the total volume of the acidic etching composition, preferably from 0.003 mol/L to 0.075 mol/L, more preferably from 0.004 mol/L to 0.06 mol/L, even more preferably from 0.005 mol/L to 0.045 mol/L, yet even more preferably from 0.006 mol/L to 0.03 mol/L, most preferably from 0.007 mol/L to 0.016 mol/L. This primarily refers to the concentration prior to the contacting.

Preferably, in the method of the present invention, the acidic etching composition additionally comprises
(c) one or more than one, preferably one, mineral acid.

Preferred is a method of the present invention, wherein the one or more than one mineral acid comprises sulfuric acid and/or phosphoric acid, more preferably phosphoric acid, most preferably phosphoric acid is the only mineral acid in the acidic etching composition, even most preferably phosphoric acid is the only acid in the acidic etching composition. This alternatively means that in some cases a method of the present invention is preferred, wherein the acidic etching composition is substantially free of, preferably does not comprise, sulfuric acid.

Preferred is a method of the present invention, wherein the one or more than one mineral acid has a total concentration ranging from 7 mol/L to 12 mol/L, based on the total volume of the acidic etching composition, preferably from 8 mol/L to 11 mol/L.

Even more preferred is a method of the present invention, wherein in the acidic etching composition, the phosphoric acid has a concentration ranging from 7.4 mol/L to 11.8 mol/L, based on the total volume of the acidic etching composition, preferably from 7.8 mol/L to 11.5 mol/L, more preferably from 8.2 mol/L to 11.2 mol/L, even more preferably from 8.5 mol/L to 11 mol/L, most preferably from 8.7 mol/L to 10.8 mol/L, even most preferably from 9.2 mol/L to 10.5 mol/L.

Preferably, in the method of the present invention, the acidic etching composition additionally comprises
(d) one or more ions selected from the group of elements consisting of silver, bismuth, cerium, and lead.

Ions as defined in (d) are typically utilized for electrolytic regeneration, most preferably silver ions.

Preferably, the silver ions comprise silver (I) and/or silver (II) ions, most preferably at least silver (I) ions.

Preferably, the bismuth ions comprise bismuth (III) and/or (IV) ions.

Preferably, the lead ions comprise lead (II) ions.

Most preferably, the one or more ions selected from (d) comprise silver ions, preferably silver (I) and/or silver (II) ions, most preferably at least silver (I) ions.

Preferred is a method of the present invention, wherein the ions defined in (d) have a total concentration ranging from 0.0001 mol/L to 0.2 mol/L, based on the total volume of the acidic etching composition, preferably from 0.0005 mol/L to 0.15 mol/L, most preferably from 0.001 mol/L to 0.1 mol/L.

More preferred is a method of the present invention, wherein the silver ions have a total concentration ranging from 0.0001 mol/L to 0.2 mol/L, based on the total volume of the acidic etching composition, preferably from 0.0003 mol/L to 0.15 mol/L, most preferably from 0.0005 mol/L to 0.1 mol/L. This most preferably applies, if silver ions are the only ions according to (d).

Further preferred is a method of the present invention, wherein in the etching composition the silver (I) ions have a concentration ranging from 0.0001 mol/L to 0.09 mol/L, preferably from 0.0002 mol/L to 0.07 mol/L, more preferably from 0.0005 mol/L to 0.05 mol/L, even more preferably from 0.0007 mol/L to 0.03 mol/L, most preferably from 0.001 mol/L to 0.01 mol/L, even most preferably from 0.0015 mol/L to 0.005 mol/L. This most preferably applies, if silver ions are the only ions according to (d).

In some cases, a method of the present invention is preferred, wherein the acidic etching composition comprises alkali ions, most preferably sodium ions, preferably in a total amount ranging from 0.002 mol/L to 0.5 mol/L, based on the total volume of the acidic etching composition, preferably 0.004 mol/L to 0.3 mol/L.

Preferred is a method of the present invention, wherein (a), (b), (c), and (d) form 90 wt.-% or more of the total weight of the acidic etching composition, preferably 92 wt.-% or more, more preferably 94 wt.-% or more, even more preferably 96 wt.-% or more, most preferably 98 wt.-% or more, even most preferably 99 wt.-% or more.

Preferred is a method of the present invention, wherein in step (C) the etching composition has a density in a range from 1.15 g/cm³ to 1.51 g/cm³, referenced to a temperature of 25° C., preferably from 1.22 g/cm³ to 1.41 g/cm³, more preferably from 1.24 g/cm³ to 1.39 g/cm³, most preferably from 1.26 g/cm³ to 1.38 g/cm³. This typically also means that the acidic etching composition has a comparatively low vapor pressure.

Preferred is a method of the present invention, wherein the acidic etching composition is substantially free of, preferably does not comprise, a methane sulfonic acid and salts thereof, preferably is substantially free of, preferably does not comprise, a C1 to C4 alkyl sulfonic acid and salts thereof, most preferably is substantially free of, preferably does not comprise, a C1 to C4 sulfonic acid and salts thereof.

Preferred is a method of the present invention, wherein the acidic etching composition is substantially free of, preferably does not comprise, bromide and iodide anions, preferably is substantially free of, preferably does not comprise, chloride, bromide, and iodide anions, most preferably is substantially free of, preferably does not comprise, halide anions.

Preferred is a method of the present invention, wherein the acidic etching composition is substantially free of, preferably does not comprise, trivalent chromium ions and hexavalent chromium compounds, preferably is substantially free of, preferably does not comprise, any compounds and ions comprising chromium.

Preferred is a method of the present invention, wherein the acidic etching composition is substantially free of, preferably does not comprise, palladium and/or copper ions, more preferably is substantially free of, preferably does not comprise, palladium and/or copper compounds, most preferably is substantially free of, preferably does not comprise, any activator for subsequent metallization. In other words, preferably, the acidic etching composition is not simultaneously an activation composition. It is rather preferred that an activation, most preferably with palladium, is carried out in a subsequent, individual step.

Preferred is a method of the present invention, wherein the acidic etching composition is substantially free of, preferably does not comprise, manganese (II) ions.

Without wishing to be bound by theory, it is assumed that in the very preferred permanganate-based acidic etching composition, besides permanganate ions manganese species with an oxidation number of (III) and/or (IV) are present.

In the method of the present invention, the contacting in step (C) is an immersion-free contacting, namely an immersion-free dispensing of the acidic etching composition onto the plastic substrate (for further information see also the text above). This dispensing denotes likewise or alternatively a distributing (in a sense of spreading) of a liquid over the plastic substrate without an immersion, submersion, and dipping. This means that the acidic etching composition is actively dispensed, spread, and distributed, respectively, over the plastic substrate, most preferably with a pressure.

Preferred is a method of the present invention, wherein the immersion-free dispensing comprises, preferably is (most preferably alternatively denotes), a spraying, a flushing, and/or a rinsing, most preferably a spraying.

In the context of the present invention, spraying results in a spray of the acidic etching composition for contacting the plastic substrate in step (C). This preferably includes (additionally or alternatively) a spray mist, an aerosol, and a nebulous dispersion. The spray preferably includes (at least partly) very fine spray droplets (e.g. from about 100 nm diameter) even up to medium and larger droplets (e.g. 10 μm, 100 μm, 500 μm, 1000 μm). This also includes a spray with droplets of a very homogeneous droplet size as well as a spray with droplets of strongly varying droplet sizes. However, very preferred is a mostly homogeneous spraying and a spray, respectively, with fine up to medium size droplets.

In the context of the present invention, flushing results in a flush of the acidic etching composition. This preferably includes a squirting, a purging, as well as a jet of the acidic etching composition, preferably directly directed towards the plastic substrate. Typically, this kind of dispensing is very directional in bringing the acidic etching composition onto the plastic substrate.

In the context of the present invention, rinsing includes a screen rinse (including a laminar flow, a waterfall rinse, etc.), trickling, dripping, and showering of the acidic etching composition over the plastic substrate. This is preferably carried out without applying additional pressure.

Generally preferred is a method of the present invention, wherein the contacting in step (C) comprises a dispensing of the acidic etching composition in a quantity ranging from 50 L/m²/min to 250 L/m²/min, based on total spray window area, preferably from 75 L/m²/min to 225 L/m²/min, more preferably from 100 L/m²/min to 200 L/m²/min, most preferably from 125 L/m²/min to 175 L/m²/min. In the context of the present invention, this parameter is also named specific volume flow.

Preferred is a method of the present invention, wherein in step (C) the plastic substrate and the one or more than one dispense nozzle has a distance within a range from 5 cm to 30 cm, preferably from 8 cm to 26 cm, more preferably from 10 cm to 22 cm.

Preferred is a method of the present invention, wherein in step (C) the immersion-free dispensing is carried out with a dispensing pressure. The dispensing pressure denotes with how much force the acidic etching composition is dispensed (i.e. pressed) onto the plastic substrate. A pressure is most preferred in combination with spraying.

More preferred is a method of the present invention, wherein in step (C) the immersion-free dispensing is carried out with a dispensing pressure ranging from 0.3 bar to 5 bar, more preferably from 0.5 bar to 4 bar, even more preferably from 0.7 bar to 3 bar, most preferably from 1 bar to 2 bar.

Most preferred is a spraying and a spray, respectively, because among the aforementioned various kinds of dispensing, spraying requires comparatively less volume of the acidic etching composition compared to flushing and rinsing and at the same time provides very good wetting.

Most preferred is a method of the present invention, wherein in step (C) the immersion-free dispensing comprises, preferably is, a spraying with a spray pressure ranging from 0.3 bar to 5 bar, more preferably from 0.5 bar to 4 bar, even more preferably from 0.7 bar to 3 bar, most preferably from 1 bar to 2 bar.

Typically, the temperature of the acidic etching composition has a significant impact on the etching result, particularly in dependence over time.

Preferred is a method of the present invention, wherein during the contacting in step (C) the acidic etching composition has a temperature of 25° C. or more, preferably of 28° C. or more, more preferably of 30° C. or more, even more preferably of 33° C. or more, most preferably of 35° C. or more, even most preferably of 39° C. or more. This is also commonly called etching temperature. Typically, the higher the temperature, the stronger the etching effect. However, if the temperature is too high, a detrimental decomposition is observed. In this regard, detrimental denotes that the decomposition is too faster and strong that a reasonable regeneration cannot carried out any longer. Thus, the temperature most preferably does not exceed 60° C.

Therefore, more preferred is a method of the present invention, wherein during the contacting in step (C) the acidic etching composition has a temperature ranging from 25° C. to 60° C., preferably from 28° C. to 55° C., more preferably from 30° C. to 50° C., even more preferably from 33° C. to 47° C., most preferably from 35° C. to 44° C., even most preferably from 39° C. to 42° C.

As already indicated above, the method of the present invention allows a temperature management. This most preferably aims for the purpose to provide during the contacting a comparatively high temperature, wherein in contrast during the regeneration the temperature is lower in order to prevent or reduce the undesired decomposition. Thus, in some cases a method of the present invention is preferred, wherein in the etching compartment (10) the acidic etching composition during the contacting has a higher temperature than the dispensed acidic etching composition treated in the regeneration compartment (30).

More preferred is a method of the present invention, wherein in the etching compartment (10) the acidic etching composition during the contacting has a temperature of 39° C. or more, wherein the dispensed acidic etching composition treated in the regeneration compartment (30) has a temperature of below 39° C.

Most preferably, a temperature management includes and utilizes, respectively, a heat exchanger.

However, in other cases, a method of the present invention is preferred, wherein the temperature of the acidic etching composition and the dispensed acidic etching composition is substantially identical. This means that the temperature is maintained around a desired temperature with only a very small temperature variation, most preferably a temperature of 40° C.±1° C. is maintained. In such a case, most preferably no additionally energy and equipment for cooling is required.

The duration of the contacting with the acidic etching composition is commonly called etching time. Preferred is a method of the present invention, wherein the contacting in step (C) is carried out for a time ranging from 1 minute to 120 minutes, preferably from 2 minutes to 90 minutes, more preferably from 3 minutes to 70 minutes, even more preferably from 4 minutes to 50 minutes, most preferably from 5 minutes to 30 minutes. In some cases, 5 minutes to 15 minutes are very preferred.

Preferred is a method of the present invention, wherein during step (C) substantially no, preferably no, manganese dioxide (MnO₂) is deposited onto the etched plastic substrate. Thus, in the method of the present invention, no step is needed (and therefore not applied) in order to reduce manganese dioxide on the etched plastic substrate; i.e. in order to dissolve MnO₂ by chemical reduction through a reducing agent. Thus, preferably, the etched plastic substrate obtained after step (C) is not contacted with a respective composition comprising a reducing agent. A typical rinsing with water is sufficient. Therefore, preferred is a method of the present invention further comprising after step (C) a rinsing with water, more preferably a rinsing with water free of a reducing agent capable to chemically reduce manganese dioxide.

Further, in step (C) of the method of the present invention, a dispensed acidic etching composition is obtained as a result of this step. In the context of the present invention, this primarily comprises a large portion of the acidic etching composition which finally was utilized for etching, which also means that in this portion the one or more than one manganese species largely has a lower oxidation number than before the contacting. This means, they are in a more reduced state after the contacting, primarily due to the etching but also due to decomposition. However, the dispensed acidic etching composition may additionally comprise a portion of the acidic etching composition which was not yet in contact with the plastic substrate or simply has missed the plastic substrate (and therefore will not come anymore in contact with the plastic substrate). This portion is typically smaller in comparison to the portion involved in etching. As a matter of fact, compared to the acidic etching composition, in the dispensed acidic etching composition the one or more than one manganese species on average has a lower oxidation number. As a result thereof, at least a portion of the dispensed acidic etching composition is treated in the regeneration compartment for regeneration by applying an electrical current. Preferably, all of the dispensed acidic etching composition is treated in the regeneration compartment.

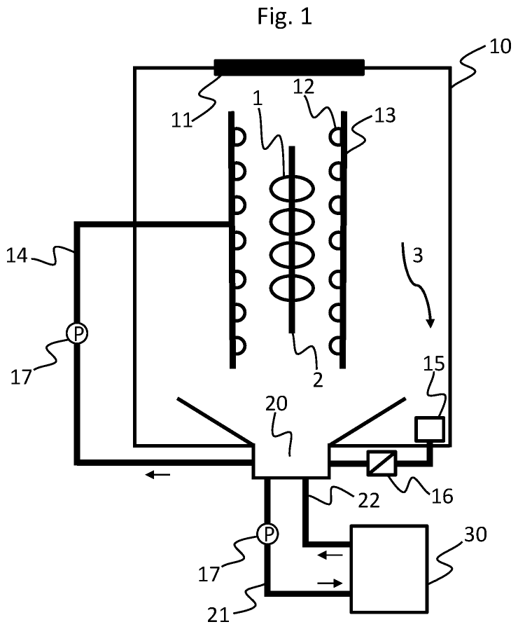

Preferred is a method of the present invention, wherein said portion of the dispensed acidic etching composition is transferred by means of a transfer line (such as an inlet regeneration line, see FIG. 1) into the regeneration compartment, most preferably supported by means of a pump. In the regeneration compartment, the acidic etching composition is formed and reformed, respectively. Preferred is a method of the present invention, wherein the portion treated in the regeneration compartment is at least temporarily not present in the etching compartment. Thus, preferably, the etching and the regeneration are carried out at separated locations and in distinct devices, respectively.

After regeneration, the treated portion is transferred back to the acidic etching composition. Thus, the method of the present invention involves a circular flow. Preferred is a method of the present invention, wherein the treated and returned portion of the dispensed acidic etching composition denotes a replenishment and replenishing, respectively, of the acidic etching composition for a further step (c) within the method of the present invention.

Preferred is a method of the present invention, wherein the method is carried out repeatedly. This means that the method of the present invention comprises a first, second, third, etc. step (C). This likewise applies preferably to step (B) and preferably therefore includes a new (in the sense of a further) plastic substrate in each step (C). Thus, the method of the present invention is preferably carried out in a loop. This likewise includes that most preferably repeatedly, most preferably continuously, a portion is treated in the regeneration compartment and returned to the acidic etching composition.

### Further Steps

After step (C), i.e. after etching the plastic substrate, typically a metallization follows.

Preferred is a method of the present invention additionally comprising after step (C) the step
(D) contacting the etched plastic substrate with an activation composition such that an activated plastic substrate is obtained;
and/or (preferably and)
(E) contacting the etched plastic substrate or the activated plastic substrate (preferably the activated plastic substrate) with a first metalizing composition such that a first metal or metal alloy layer is deposited thereon resulting in a first metalized plastic substrate.

In this regard, the method of the present invention is preferably also a method for activating a plastic substrate, respectively, a method for metallizing a plastic substrate.

In the method of the present invention, preferably step (D) is a step separated and independent from step (C). In other words, the acidic etching composition utilized in step (C) is preferably not the activation composition utilized in step (D).

In step (D) of the method of the present invention, the etched plastic substrate is contacted with an activation composition.

Preferred is a method of the present invention, wherein in step (D) the activation composition comprises palladium, preferably dissolved palladium ions or colloidal palladium, most preferably colloidal palladium. Preferably, the colloidal palladium comprises tin.

Preferred is a method of the present invention, wherein in step (D) the activation composition comprises palladium in a total concentration ranging from 20 mg/L to 200 mg/L, based on the total volume of the activation composition, preferably ranging from 40 mg/L to 150 mg/L, even more preferably from 50 mg/L to 110 mg/L, most preferably from 55 mg/L to 80 mg/L. Preferably, this total concentration includes both dissolved palladium ions and colloidal palladium. Above concentrations are based on the element palladium.

Preferred is a method of the present invention, wherein in step (D) the activation composition has a temperature ranging from 25° C. to 70° C., preferably from 30° C. to 60° C., even more preferably from 36° C. to 50° C., most preferably from 39° C. to 46° C.

Preferred is a method of the present invention, wherein in step (D) the contacting is carried out for a time ranging from 1 minute to 15 minutes, preferably from 2 minutes to 12 minutes, even more preferably from 3 minutes to 9 minutes, most preferably from 4 minutes to 7 minutes.

Preferred is a method of the present invention, wherein step (D) comprises step
(D-1) contacting the activated plastic substrate with an accelerator composition to modify the activated plastic substrate, the accelerator composition comprising
   no reducing agent but at least one complexing agent for tin ions, if in step (D) the activation composition comprises colloidal palladium, or
   a reducing agent for reducing palladium ions to metallic palladium, if in step (D) the activation composition comprises palladium ions but no colloidal palladium.

Preferred is a method of the present invention, wherein in step (D-1) the accelerator composition comprises no reducing agent but at least one complexing agent for tin ions and is acidic, preferably comprising in addition sulfuric acid.

In the context of the present invention, step (D-1) as defined above is carried out after contacting the etched plastic substrate with an activation composition such that an activated plastic substrate is obtained.

After step (D-1) typically a fully activated plastic substrate is obtained.

In step (E) of the method of the present invention, the fully etched plastic substrate or the activated plastic substrate is contacted with a first metalizing composition such that a first metal or metal alloy layer is deposited thereon resulting in a first metalized plastic substrate.

Thus, step (E) either follows after the activation in step (D) or is applied to the etched plastic substrate as a direct metallization, which does not require an activation. In the latter case, step (D) is not needed. However, preferred is a method of the present invention, wherein steps (D) and (E) are carried out.

Preferred is a method of the present invention, wherein in step (E) the first metalizing composition comprises nickel ions, preferably nickel ions and a reducing agent for reducing said nickel ions, such that the first metal or metal alloy layer is a nickel or nickel alloy layer, respectively. Thus, the first metallized plastic substrate is preferably a first nickel or nickel alloy metallized plastic substrate.

Preferred is a method of the present invention, wherein in step (E) the first metalizing composition is alkaline, preferably has a pH ranging from 8.0 to 11.0, preferably from 8.2 to 10.2, more preferably from 8.4 to 9.3, most preferably from 8.6 to 9.0. However, in some rare cases, a method of the present invention is preferred, wherein in step (E) the first metalizing composition is alternatively acidic, preferably weakly acidic, most preferably has a pH ranging from 6 to 6.9.

Preferred is a method of the present invention, wherein in step (E) the first metalizing composition has a temperature ranging from 18° C. to 60° C., preferably from 20° C. to 55° C., even more preferably from 23° C. to 50° C., most preferably from 26° C. to 45° C.

Preferably, the first metallized plastic substrate is subsequently further metallized.

Preferred is a method of the present invention additionally comprising after step (D) or (E), the step
(F) contacting the activated plastic substrate or the first metallized plastic substrate with a second metalizing composition such that a second metal or metal alloy layer is deposited thereon resulting in a second metalized plastic substrate.

If step (F) follows step (D), step (E) is preferably omitted and the second metalizing composition basically corresponds to the first metalizing composition. However, this is less preferred. More preferably steps (E) and (F) are carried out consecutively. This does not exclude a rinsing step.

Step (F) preferably allows at least two alternatives.

In a first alternative, preferred is a method of the present invention, wherein in step (F) the second metalizing composition comprises copper ions, preferably in a concentration ranging from 0.002 mol/L to 0.4 mol/L, based on the total volume of the second metalizing composition, more preferably ranging from 0.004 mol/L to 0.25 mol/L, even more preferably ranging from 0.005 mol/L to 0.1 mol/L, most preferably ranging from 0.007 mol/L to 0.04 mol/L. Most preferably, the copper ions are copper (II) ions.

More preferred is a method of the present invention in the first alternative, wherein the second metalizing composition is acidic, preferably has a pH of 2 or below, preferably of 1 or below. In some cases, a method is alternatively preferred, wherein the second metalizing composition is alkaline and comprising copper ions.

In some cases, preferred is a method of the present invention, wherein the second metalizing composition comprises pyrophosphate, most preferably comprises pyrophosphate and is alkaline.

More preferred is a method of the present invention in the first alternative, wherein the second metalizing composition comprises at least one acid (and most preferably is acidic, preferably as defined above), preferably at least one inorganic acid, more preferably at least sulfuric acid. Preferably the at least one acid (more preferably the at least one inorganic acid, most preferably the at least sulfuric acid) has a total concentration ranging from 0.001 mol/L to 0.5 mol/L, based on the total volume of the second metalizing composition, preferably ranging from 0.003 mol/L to 0.3 mol/L, more preferably ranging from 0.005 mol/L to 0.1 mol/L, most preferably ranging from 0.007 mol/L to 0.07 mol/L.

More preferred is a method of the present invention in the first alternative, wherein the second metalizing composition has a temperature ranging from 20° C. to 80° C., preferably ranging from 21° C. to 60° C., more preferably ranging from 22° C. to 45° C., even more preferably ranging from 23° C. to 40° C., most preferably ranging from 24° C. to 35° C.

More preferred is a method of the present invention in the first alternative, wherein the second metalizing composition is substantially free of, preferably does not comprise, a reducing agent for copper ions.

Most preferred is a method of the present invention in the first alternative, wherein the second metalizing composition is an immersion copper composition. Thus, the copper ions are not reduced to metallic copper by means of a reducing agent. This is also known as replacement plating.

In a second alternative, preferred is a method of the present invention, wherein in step (F) the second metalizing composition comprises nickel ions.

More preferred is a method of the present invention in the second alternative, wherein the second metalizing composition is substantially free of, preferably does not comprise, a reducing agent for nickel ions.

More preferred is a method of the present invention in the second alternative, wherein the second metalizing composition is acidic, preferably has a pH ranging from 1.0 to 5.0, preferably from 2.0 to 4.5, more preferably from 2.8 to 4.0, most preferably from 3.3 to 3.7.

More preferred is a method of the present invention in the second alternative, wherein the second metalizing composition has a temperature ranging from 25° C. to 70° C., preferably from 35° C. to 65° C., even more preferably from 45° C. to 61° C., most preferably from 52° C. to 58° C.

More preferred is a method of the present invention in the second alternative, wherein the contacting is carried out for a time ranging from 1 minute to 10 minutes, preferably from 2 minutes to 8 minutes, most preferably from 2.5 minutes to 5.5 minutes.

More preferred is a method of the present invention in the second alternative, wherein an electrical current is applied, preferably ranging from 0.3 A/dm² to 10.0 A/dm², preferably ranging from 0.5 A/dm² to 8.0 A/dm², more preferably ranging from 0.8 A/dm² to 6.0 A/dm², even more preferably ranging from 1.0 A/dm² to 4.0 A/dm², most preferably ranging from 1.3 A/dm² to 2.5 A/dm². Thus, the second alternative is preferably an electrolytic nickel deposition.

More preferred is a method of the present invention in the second alternative, wherein the second metalizing composition comprises chloride ions and/or (preferably and) boric acid.

Most preferred is a method of the present invention in the second alternative, wherein the second metalizing composition is a Watts Nickel composition. Thus, preferred is a method of the present invention in the second alternative, wherein the second metalizing composition comprises chloride ions, sulfate ions, and boric acid.

After step (F), the second metallized plastic substrate is preferably further metallized.

Preferred is a method of the present invention additionally comprising after step (F) the step
(G) contacting the second metalized plastic substrate with a third metalizing composition such that a third metal or metal alloy layer is electrolytically deposited thereon resulting in a third metalized plastic substrate.

Preferred is a method of the present invention, wherein the third metalizing composition comprises copper ions, preferably in a concentration ranging from 0.05 mol/L to 3 mol/L, based on the total volume of the third metalizing composition, more preferably ranging from 0.1 mol/L to 2 mol/L, even more preferably ranging from 0.2 mol/L to 1.5 mol/L, most preferably ranging from 0.3 mol/L to 1 mol/L.

Preferred is a method of the present invention, wherein in step (G) an electrical current is applied, preferably a direct current.

More preferred is a method of the present invention, wherein the third metalizing composition is acidic or alkaline. In this context, the acidic third metalizing composition represents a first alternative; the alkaline third metalizing composition a second alternative, wherein the first alternative is more preferred.

More preferred is a method of the present invention, wherein the third metalizing composition according to the first alternative has a pH of 2 or less, preferably of 1 or less.

More preferred is a method of the present invention, wherein the third metalizing composition according to the first alternative comprises at least one acid, preferably at least one inorganic acid, most preferably at least sulfuric acid. Preferably the at least one acid (more preferably the at least one inorganic acid, most preferably the at least sulfuric acid) has a total concentration ranging from 0.1 mol/L to 5 mol/L, based on the total volume of the second metalizing composition, preferably ranging from 0.2 mol/L to 3 mol/L, more preferably ranging from 0.3 mol/L to 2 mol/L, most preferably ranging from 0.4 mol/L to 1.5 mol/L.

More preferred is a method of the present invention, wherein the third metalizing composition according to the first alternative comprises chloride ions, preferably chloride ions in a total concentration of 500 mg/L or less, preferably 300 mg/L or less, most preferably 150 mg/L or less.

More preferred is a method of the present invention, wherein the third metalizing composition according to the first alternative has a temperature ranging from 20° C. to 49° C., preferably ranging from 22° C. to 43° C., more preferably ranging from 24° C. to 39° C., most preferably ranging from 26° C. to 35° C.

More preferred is a method of the present invention, wherein the third metalizing composition according to the second alternative has a pH ranging from 7.1 to 12, preferably ranging from 7.4 to 11, most preferably ranging from 7.6 to 10.

More preferred is a method of the present invention, wherein the third metalizing composition according to the second alternative comprises cyanide ions or pyrophosphate ions, preferably pyrophosphate ions.

More preferred is a method of the present invention, wherein the third metalizing composition according to the second alternative has a temperature ranging from 50° C. to 70° C.

In the context of the present invention, the terms first, second, and third metalized plastic substrate denotes a correspondence to the respective step as defined above in the text, rather than a numerical amount/number of metalized plastic substrates.

Preferred is a method of the present invention, wherein after step (G) the third metallized plastic substrate is contacted with one or more than one further metalizing composition, wherein at least one thereof comprises trivalent chromium ions such that a chromium or chromium alloy metal layer, respectively, is deposited.

Most preferably, the chromium or chromium alloy metal layer, respectively, is the outermost metallic layer. Thus, most preferably the method of the present invention is for metalizing a plastic substrate, wherein the metalizing comprises a chromium deposition, preferably a decorative chromium deposition.

In the context of the present invention, preferably a sequence of steps, in particular of metallization steps, is defined. Preferably, this does not exclude intermediate steps in between those steps, such as rinsing steps. Thus, preferred is a method of the present invention, wherein at least between one of the steps (B), (C), and preferably (D) to (G) an intermediate step is carried out, most preferably a rinsing step.

The invention will now be further illustrated by reference to the figure and the following examples below.

In a reservoir (20) the acidic etching composition utilized in the method of the present invention is provided. The acidic etching composition is a permanganate-based acidic etching composition comprising 9 mol/L to 11 mol/L phosphoric acid.

Via supply line (14) the acidic etching composition is transferred from reservoir (20) into etching compartment (10) supported by a pump (17).

In etching compartment (10), dispense line (13) is distributing the acidic etching composition to a plurality of dispense nozzles (12), which are preferably spray nozzles. In FIG. 1, dispense line (13) is shown twice. Only for reasons of simplicity it is not shown that also the second dispense line (13) is connected with supply line (14).

Between the two dispense lines (13) with their respective plurality of dispense nozzles (12), a rack (2) with a plurality of plastic substrates (1) is positioned. Rack (2) with the respective plurality of plastic substrates (1) is vertically moved into etching compartment (10) through opening (11) equipped with a door. After rack (2) is properly positioned, the door is shut and etching compartment (10) is closed but not totally air-sealed.

To etch the plurality of plastic substrates (1) on rack (2), the etching process is initiated by dispensing, preferably spraying, the acidic etching composition onto the plurality of plastic substrates (1) with a dispensing pressure, respectively a spray pressure, ranging from 1 to 2 bar. As a result thereof, a homogeneous etching over all plastic substrates (1) is obtained. During the etching, the acidic etching composition is distributed over the plurality of plastic substrates (1) on rack (2), resulting in a dispensed acidic etching composition. The dispensed acidic etching composition is collected in reservoir (20). In some cases, reservoir (20) is spatially divided from etching compartment (10) but fluidically connected via pipes or transfer lines.

To avoid escape of the acidic etching composition during step (C) and contamination outside etching compartment (10), a moderate flow of air, preferably a laminar air flow, is applied, forming vertical gas flow (3) from the top to the bottom. Vertical gas flow (3) is applied at least when the door of opening (11) is opened. Ventilation duct (15) is absorbing vertical gas flow (3) and along with it primarily mist of the dispensed acidic etching composition. In liquid separator (16) the gas (i.e. here air) is separated from any liquid, wherein the liquid is replenished into reservoir (20) via a transfer line.

In FIG. 1, the acidic etching composition in reservoir (20) has about the same temperature as the acidic etching composition dispensed through the plurality of dispense nozzles (12).

Therefore, a heating unit (not shown) is applying heat to reservoir (20) and thereby maintaining a comparatively constant temperature during the entire method. However, in some cases, the dispensed acidic etching composition is allowed to cool down and being regenerated in regeneration compartment (30) at a lower temperature. In such a case, the acidic etching composition is brought to temperature by a heating unit shortly before the contacting with the plastic substrate.

For regeneration, the dispensed acidic etching composition is treated in regeneration compartment (30) and transferred via inlet regeneration line (21). In the regeneration compartment (30) an electrical current is applied, preferably continually. Since permanganate ions are an active etching species, permanganate ions are continually formed (i.e. re-oxidized) in regeneration compartment (30), at least in repeated intervals, most preferably continually. Regenerated, i.e. re-oxidized, dispensed acidic etching composition is returned to reservoir (20) via outlet regeneration line (22).

### EXAMPLES

The invention will now be illustrated by reference to the following non-limiting example.

### Example (A), Spraying+Electrolytic Regeneration; According to the Invention

In step (A) the etching compartment was provided in form of a box (dimensions of 1.4 m×0.9 m×0.7 m) made of polyvinylidene fluoride (PVDF). The box has a top opening, which can be closed and opened by a door. The total spray window area was about 100 dm².

In the etching compartment, 112 spray nozzles as dispense nozzles (40 on each long site and 16 on each short site (i.e. lateral)) were distributed over 14 dispense lines, corresponding to about 1.1 dispense nozzles per dm² total spray window area. Later performed trials in a bigger scale showed that these lateral nozzles can be omitted without any negative effects on etching effect. Each spray nozzle was made of polyvinylidene fluoride (PVDF).

The etching compartment was not air-sealed during etching. A vertical air flow of ambient air from top to bottom was applied to prevent dangerous spray mist to escape. The vertical air flow had a flow rate of about 500 m³/h while the etching compartment was open for lifting in and out the rack with the plurality of plastic substrates. In order to suck off the vertical air flow, two ventilation ducts were installed near the bottom of the etching compartment. A liquid separator was used to separate ambient air from the spray mist.

A separate tank fluidically connected by lines with the etching compartment formed the reservoir. In this example, a total volume of 200 L acidic etching composition was utilized (and placed in the reservoir), which is significantly less compared to a common immersion/dipping process. The reservoir was heated in such a way that the acidic etching composition had a temperature of about 40° C. to 41° C. before it was actively pumped through the supply line and the dispense lines to the plurality of plastic substrates in the etching compartment.

The regeneration compartment 30 for regeneration of the dispensed acidic etching composition comprised 6 subunits, each comprising a single cathode and a stack of 9 anode layers (each anode layer being an expanded metal, having a distance of 1 to 5 mm to the next one, and having a surface factor of about 2). The cathode was made of stainless steel and each anode layer of platinized niobium. The anodic current technically applicable to each subunit is ranging from 40 to 300 A, wherein a comparatively low electrical current was indeed applied and required; see Table 1 below). The electrical current was permanently applied. The distance between the cathode and the stack of anode layers was about 5 to 30 mm. Each stack of anode layers had a total effective anode surface area A₁ of about 300 dm², wherein the total effective cathode surface area A₂ was about 30 dm², resulting in a A₁:A₂ ratio of about 10. The cathode and the stack of anode layers was separated by a Nafion-type-membrane, resulting in an anolyte (which is the to be regenerated dispensed acidic etching composition) and a catholyte comprising phosphoric acid. The cathode as well as the stack of anode layers had a vertical orientation.

In step (B) of the method of the present invention, a plurality of round or bar-shaped plastic substrates (ABS and ABS-PC, each having surface dimensions ranging from 0.1 dm² to 10 dm²) was used. The plastic substrates were mounted on a rack. The rack was vertically lifted into the etching compart and positioned accordingly.

Prior to contacting the plastic substrates with the acidic etching composition, they were pretreated for 10 minutes by contacting them with a cleaning solution (Uniclean 151, product of Atotech) and subsequently rinsed. No swelling or swelling composition was utilized and needed, respectively. Thus, no contacting with an organic solvent was involved. As a result, cleaned plastic substrates were obtained.

After the cleaning, the cleaned plastic substrates were contacted for 1 minute with an aqueous surfactant solution to improve wettability. No rinse was applied between this step and subsequent step (C). It should be mentioned that the use of surfactants is not necessarily needed.

In step (C) a permanganate-based etching composition was utilized, comprising about 10 mol/L phosphoric acid, about 10 mmol/L permanganate ions (total manganese species concentration of about 60 mmol/L) and about 1 to 2 mmol/L silver (I) ions.

In step (C) the acidic etching composition was sprayed onto the plastic substrates with a spray pressure of 2 bar to form a spray. Etching was carried out with a temperature of about 40° C. and for time lengths of 8 minutes for ABS plastic substrates and 15 minutes for ABS-PC plastic substrates. During the etching, the dispensed acidic etching composition was collected in the reservoir and from there partly transferred into the regeneration compartment and subsequently returned into the reservoir.

The etching quality was evaluated and is summarized in Table 1 below.

After step (C) a rinsing was carried out with water.

In step (D) the etched plastic substrates were contacted with an activation composition comprising colloidal palladium (approximately: 50 mg/L Pd, temperature 40° C., contact time 5 minutes) to obtain activated plastic substrates.

In a subsequent step (D-1) the activated plastic substrates were contacted with an accelerator composition for 3 minutes at 45° C., comprising no reducing agent but a complexing agent for tin ions. As a result, fully activated plastic substrates were obtained.

Prior to step (E) a rinsing was carried out with water.

In step (E) the fully activated and rinsed plastic substrates were contacted with the first metalizing composition in order to obtain a first metalized plastic substrate. The fully activated plastic substrate was contacted with an alkaline (pH approximately 8.6 to 9.0) first metalizing composition (having a temperature of approximately 40° C.; contact time about 10 minutes) for electroless nickel plating. The first metalizing composition comprised approximately 3.5 g/L nickel ions and approximately 15 g/L hypophosphite ions as a reducing agent for nickel ions to obtain nickel alloy-metallized plastic substrates.

In step (F), the nickel alloy-metallized plastic substrates were contacted for approximately 0.5 min with an acidic second metalizing composition comprising copper (II) ions (immersion copper-i.e. copper replacement plating; pH<1; temperature about 25° C., no reducing agent).

Afterwards, the second metalized plastic substrates with the second metal layer (i.e. copper) were rinsed with water.

In step (G), after rinsing, the respective plastic substrates were contacted with a third metalizing composition (acidic pH) in order to obtain a third metalized plastic substrate having a copper layer with a layer thickness of more than 30 μm (contact time about 70 min, 25° C., 40 g/L copper ions; electrolytic copper plating with about 4 A/dm²).

Subsequently, further metallization steps were carried out to finally deposit a chromium layer. The metalized plastic substrates having a copper layer with a layer thickness of more than 30 μm were subjected to at least one more nickel plating.

In a final metallization step, the respective plastic substrates were contacted with a further metalizing composition in order to obtain a metalized plastic substrate having a chromium layer, the further metalizing composition comprising 15 g/L to 30 g/L trivalent chromium and boric acid (acidic pH, 25° C. to 60° C.).

Finally, the optical quality of the chromium layer was evaluated by analyzing coverage and optical defects, in particular blisters. As a result, no haze and no other optical defects were observed, in particular no blisters or other physical defects. In particular, the chromium layer showed a very homogeneous optical distribution. Although this result was obtained also in all further Examples (see below), it was observed that less plating defects were obtained for Examples (A) and (B). It was observed that immersion-free dispensing avoids gas bubbles from adhering to a plastic substrate with particularly a sophisticated surface geometry (e.g. with slots, grooves, inner edges, etc. on the surface). Such a geometry often results in etching defects and subsequently in plating defects, respectively.

Furthermore, plastic substrates with the final chromium layer also passed the PV1200 thermocycle test (96 h, including up to +80° C. and −40° C. over 8 cycles).

For adhesion tests, the respective plastic substrates obtained after step (G) (i.e. plated with copper) were subjected to a common test. The adhesion values for ABS and ABS-PC are summarized in Table 1 below.

Compared to the following Examples, it is only Example (A) showing a combination of less plating defects for plastic substrates with a sophisticated surface geometry and significantly reduced energy and chemistry consumption.

### Example (B), Spraying+Feed and Bleed; Comparative

Example (B) was carried out as example (A) with the following changes:

No regeneration compartment was provided and, thus, no electrolytic regeneration was applied. Instead, in intervals, a certain partial volume of the dispensed acidic etching composition was removed with a removal rate and equally replenished by freshly prepared acidic etching composition to maintain a concentration of permanganate ions. The removal rate was about 1.5 vol.-% per hour, based on the total volume of the acidic etching composition.

In this approach, although no electrical current was needed, a significant und strongly undesired volume of waste acidic etching composition was instead obtained over time, which is environmentally and economically of great disadvantage. Similar to Example (A), Example (B) was maintained at a total volume of 200 L in order to provide sufficient amounts of acidic etching composition for spraying. However, during step (C) in Example (B), 3 L/h were removed and likewise replenished in order to maintain the volume and etching quality as reported above for Example (A).

In Example (B), the acidic etching composition did not comprise silver ions.

### Example (C), Immersion+Feed and Bleed; Comparative

Example (C) was carried out as example (B) with the following additional changes:

A common immersion/submersion/dipping was carried out in step (C) instead of the immersion-free dispensing. The respective etching bath had a total volume of 525 L, which is way more than twice of the total volume used in Examples (A) and (B).

Example (C) represents the worst-case setup from the environmental and economical perspective, including even larger amounts of waste etching composition. In order to maintain the 525 L, a removal rate of about 1.5 vol.-% was applied as in Example (B), which resulted in a removal and replenishment of about 8 L/h.

### Example (D), Immersion+Electrolytic Regeneration; Comparative

Example (D) was carried out as example (A) with the following changes:

Also here, a common immersion/submersion/dipping was carried out in step (C) instead of an immersion-free dispensing. The respective etching bath also had a total volume of 525 L as used in Example (C). However, the electrolytic regeneration required a significantly higher electrical current per subunit compared to Example (A) (see Table 1 below).

This comparative Example clearly shows the great advantage of combining an immersion-free dispensing and electrolytic regeneration as described above in Example (A).

TABLE 1
some etching parameters and result for ABS and ABS/PC

| | | | current | Waste volume | |
|---|---|---|---|---|---|
| | Plastic | volume | [A]/ | production | adhesion |
| Example | substrate | [L] | subunit | rate [L/h] | [N/mm] |
| A | ABS | 200 | 50 | — | 1.9 |
| A | ABS/PC | 200 | 50 | — | 0.7 |
| B | ABS | 200 | — | 3 | 1.5 |
| B | ABS/PC | 200 | — | 3 | 0.8 |
| C | ABS | 525 | — | 8 | 1.4 |
| C | ABS/PC | 525 | — | 8 | 0.7 |
| D | ABS | 525 | 200 | — | 1.6 |
| D | ABS/PC | 525 | 200 | — | 0.8 |

Table 1 generally shows that ABS and ABS-PC plastic substrates can be efficiently and successfully etched in basically all different Examples. In other words, the method of the present invention does not compromise the good results already obtained in common applications. In general, a minor difference of about 0.1 N/mm in adhesion is not significant.

Examples (A) to (D) above clearly show that only Example (A) avoids significant waste volume production and at the same time the lowest energy and chemistry consumption. Although the mere etching results are very similar, Example (A) provides the best economic and ecological result and is excellently suitable to replace common immersion/dipping processes.

Furthermore, it was surprisingly observed that less gas bubbles are attached to the plastic substrates in examples (A) and (B) due to the immersion-free dispensing. This in turn results in less etching defects and subsequently less plating defects. Such gas bubble defects are typical for immersion etching processes.

In addition to this it turned out that the prior step of wetting the surface of plastic substrates could be skipped without any negative effect on the etching quality in example (A) and (B).

In summary, Example (A) is the only example combining less gas bubble defects and most reduced energy and chemistry consumption without compromising the etching quality.

1. A method for etching a plastic substrate (1), the method comprising the steps:
(A) providing an etching compartment (10) and a regeneration compartment (30),
(B) providing the plastic substrate (1) in the etching compartment (10),
(C) contacting the plastic substrate (1) in the etching compartment (10) with an acidic etching composition comprising:
(a) water, and
(b) one or more than one manganese species,
such that an etched plastic substrate is obtained,
characterized in that:
the contacting in step (C) is an immersion-free dispensing of the acidic etching composition onto the plastic substrate (1), resulting in a dispensed acidic etching composition, and
at least a portion of the dispensed acidic etching composition is treated in the regeneration compartment (30) for regeneration by applying an electrical current and returned to the acidic etching composition.

2. The method of claim 1, wherein the etching compartment (10) comprises one or more than one dispense nozzle (12) for the immersion-free dispensing in step (C).

3. The method of claim 1, wherein in the etching compartment (10) the one or more than one dispense nozzle (12) at least partly comprises or entirely consists of a fluoropolymer plastic, titanium, stainless steel, combinations, and/or composites thereof.

4. The method of claim 1, wherein in the etching compartment (10) a vertical gas flow (3) is applied, to transport at least a portion of the dispensed acidic etching composition.

5. The method of claim 4, wherein the etching compartment comprises a ventilation duct (15) to suck off the vertical gas flow, the ventilation duct being connected to a liquid separator (16) to separate liquid from the gas flow.

6. The method of claim 1, wherein the regeneration compartment (20) comprises a stack of a plurality of anodes and at least one cathode.

7. The method of claim 1, wherein the stack of a plurality of anodes and the at least one cathode have a distance ranging from 0.5 mm to 100 mm.

8. The method of claim 1, wherein in the acidic etching composition the one or more than one manganese species comprises permanganate ions.

9. The method of claim 8, wherein the permanganate ions have a concentration ranging from 0.002 mol/L to 0.09 mol/L, based on the total volume of the acidic etching composition.

10. The method of claim 1, wherein the immersion-free dispensing comprises a spraying, a flushing, and/or a rinsing.

11. The method of claim 1, wherein the contacting in step (C) comprises a dispensing of the acidic etching composition in a quantity ranging from 50 L/m²/min to 250 L/m²/min, based on total spray window area.

12. The method of claim 1, wherein in step (C) the immersion-free dispensing is carried out with a dispensing pressure.

13. The method of claim 1, wherein in step (C) the immersion-free dispensing comprises a spraying with a spray pressure ranging from 0.3 bar to 5 bar.

14. The method of claim 1 wherein during the contacting in step (C) the acidic etching composition has a temperature of 25° C. or more.

15. The method of claim 1, wherein in the etching compartment (10) the acidic etching composition during the contacting has a higher temperature than the dispensed acidic etching composition treated in the regeneration compartment (30).

16. The method of claim 1, wherein the acidic etching composition is an acidic permanganate-based etching composition.
